(19) United States
(12) Patent Application Publication
(10) Pub. No.: US 2018/0014999 A1
(43) Pub. Date: Jan. 18, 2018

(54) Apparatus and Method for Filling Capsules

(71) Applicant: Jennison Quality Components, Inc., Carnegie, PA (US)

(72) Inventor: Kirk Larimer, Carnegie, PA (US)

(21) Appl. No.: 15/652,915

(22) Filed: Jul. 18, 2017

Related U.S. Application Data
(60) Provisional application No. 62/363,416, filed on Jul. 18, 2016.

(51) Int. Cl. A61J 3/07; B65B 43/44; B65B 1/16; B65B 7/16; B65B 61/28; B65B 43/50

(52) U.S. Cl. CPC A61J 3/07; B65B 61/28; B65B 43/50; B65B 1/16; B65B 7/161; B65B 43/44

(57) ABSTRACT

A magazine for use with an apparatus for filling capsules with at least one product, the magazine including a body, a first row of openings provided on a top portion of the body, a plurality of first passages extending parallel with a longitudinal axis of the body to a bottom portion of the body, one first passage in communication with each of the openings in the first row of openings, a second row of openings provided parallel to the first row of openings on the top portion of the body, and a plurality of second passages extending at an angle relative to the longitudinal axis of the body and through the body to the bottom portion of the body, one second passage in communication with each of the openings of the second row of openings.

### CROSS REFERENCE TO RELATED APPLICATION

This application claims the benefit of U.S. Provisional Patent Application No. 62/363,416, filed Jul. 18, 2016, the disclosure of which is incorporated herein by reference in its entirety.

### BACKGROUND OF THE INVENTION

### Field of the Invention

The present disclosure is generally directed to an apparatus for filling capsules with pharmaceutical products and, more particularly, to various improvements to an apparatus for filling capsules with pharmaceutical products to increase machine production.

### Description of Related Art

In the pharmaceutical industry, machines for filling capsules with pharmaceutical products are known. Such machines are configured to dose powders, pellets, liquids, and tablets into hard gelatin capsules. The powder and pellet dosing units feature dosators and pistons that move down in the powder bowl, picking up the product by means of compression and/or vacuum.

More specifically, a typical capsule filling machine includes a capsule loading station for loading the capsules from a hopper into the machine so that the capsules can be separated and then filled, a powder loading station for gathering the powdered pharmaceutical product to be loaded into the capsule and providing the powdered pharmaceutical product to the capsule, a capsule closing station for closing the filled capsule, and an ejection station for ejecting the filled capsules from the machine and gathering the filled capsules. Typical capsule filling machines may also include a rejection station where the capsules that were not properly separated are eliminated. In addition, a cleaning station may be provided after the ejection station for cleaning components of the machine of excess powder with an air jet.

The known machines for filling capsules with pharmaceutical products of the above-described type, although widely tried and tested, have some drawbacks and the machine production and output can be increased.

### SUMMARY OF THE INVENTION

The present disclosure relates to several improvements to an apparatus for filling capsules with a pharmaceutical product that increase the output of the apparatus. Specifically, in accordance with one aspect of the present disclosure, provided is a magazine for use with an apparatus for filling capsules with at least one product, the magazine including a body, a first row of openings provided on a top portion of the body, a plurality of first passages extending parallel with a longitudinal axis of the body to a bottom portion of the body, one first passage in communication with each of the openings in the first row of openings, a second row of openings provided parallel to the first row of openings on the top portion of the body, and a plurality of second passages extending at an angle relative to the longitudinal axis of the body and through the body to the bottom portion of the body, one second passage in communication with each of the openings of the second row of openings.

In one example, the first row of openings comprises five openings and the second row of openings comprises five openings parallel to the first row openings. Each of the openings of the first and second row of openings have a tapered diameter. The second passages extend at an angle of about 4 to 5 degrees through the body to the bottom portion of the body. The first passages and the second passages form a single row of openings at the bottom portion of the body.

In another example, a dosator head used with an apparatus for filling capsules with at least one product includes a solid piston block comprising a base member and a body member, the piston block being mounted for rotation around a vertical axis such that the dosator head is configured to retrieve powder from a powder bowl when in a first position and deliver powder to a capsule when in a second position; a plurality of passages machined into the piston block for individually receiving pistons with a helix-shaped opening formed along the length of each of the passages and configured to force the piston to rotate as the piston travels along the passage, wherein the dosator head is configured to deliver powder from the powder bowl into a body of the capsule.

In another example, ten passages are machined into the piston block. The pistons are configured to interact with an ejection pin comprising a three-piece main body. The main body includes a first pin portion having an opening for receiving a ball and a compression pin operatively connected to the ball. The helix-shaped openings are formed to twist along an entire length of the helix-shaped opening. Front and rear sides of the passages include a helix-shaped opening. The body member is substantially curved.

In another example, a capsule filling station for an apparatus for filling capsules with at least one product includes a dosator head configured to deliver powder from a powder bowl into a body of the capsules, the powder bowl comprising: a vacuum hopper bowl having groups of holes arranged in circular patterns around a perimeter of the vacuum hopper bowl such that when a vacuum is applied to a bottom of the vacuum hopper bowl, a vacuum is provided at each hole; and an assembly positioned over each group of holes to spread the vacuum provided at each hole.

In another example, the assembly comprises an upper plate, a screen, a middle plate, and a lower shim. The lower shim and the middle plate are positioned over one of the groups of holes on the vacuum hopper bowl to provide an area for the vacuum to spread out, such that the vacuum is applied to a plurality of slots formed in the middle plate. The screen and the upper plate transfer the vacuum to the powder in the vacuum hopper bowl. The upper plate defines a plurality of slots to transfer the vacuum to the powder in the vacuum hopper bowl. The upper plate includes three posts that pass through the screen and the middle plate and are held in a surface of the vacuum hopper bowl. The plurality of slots formed in the middle plate are substantially arcuate in shape. A number of slots formed in the middle plate corresponds to a number of dosator tubes that are provided in the dosator head.

Further aspects will now be described in the following numbered clauses.

Clause 1: A magazine for use with an apparatus for filling capsules with at least one product, the magazine comprising: a body; a first row of openings provided on a top portion of the body; a plurality of first passages extending parallel with a longitudinal axis of the body to a bottom portion of the body, one first passage in communication with each of the openings in the first row of openings; a second row of openings provided parallel to the first row of openings on the top portion of the body; and a plurality of second passages extending at an angle relative to the longitudinal axis of the body and through the body to the bottom portion of the body, one second passage in communication with each of the openings of the second row of openings.

Clause 2: The magazine of Clause 1, wherein the first row of openings comprises five openings and the second row of openings comprises five openings parallel to the first row of openings.

Clause 3: The magazine of one of Clauses 1 and 2, wherein each of the openings of the first and second row of openings has a tapered diameter.

Clause 4: The magazine of any of Clauses 1-3, wherein the second passages extend at an angle of about 4 to 5 degrees through the body to the bottom portion of body.

Clause 5: The magazine of any of Clauses 1-4, wherein the first passages and the second passages form a single row of openings at the bottom portion of the body.

Clause 6: A dosator head used with an apparatus for filling capsules with at least one product, the dosator head comprising: a solid piston block comprising a base member and a body member, the piston block being mounted for rotation around a vertical axis such that the dosator head is configured to retrieve powder from a powder bowl when in a first position and deliver powder to a capsule when in a second position; a plurality of passages machined into the piston block for individually receiving pistons with a helix-shaped opening formed along the length of each of the passages and configured to force the piston to rotate as the piston travels along the passage, wherein the dosator head is configured to deliver powder from the powder bowl into a body of the capsule.

Clause 7: The dosator head of Clause 6, wherein ten passages are machined into the piston block.

Clause 8: The dosator head of any of Clauses 6 and 7, wherein the pistons are configured to interact with an ejection pin comprising a three-piece main body.

Clause 9: The dosator head of Clause 8, wherein the main body comprises a first pin portion having an opening for receiving a ball and a compression pin operatively connected to the ball.

Clause 10: The dosator head of any of Clauses 6-9, wherein the helix-shaped openings are formed to twist along an entire length of the helix-shaped opening.

Clause 11: The dosator head of any of Clauses 6-10, wherein front and rear sides of the passages include a helix-shaped opening.

Clause 12: The dosator head of any of Clauses 6-11, wherein the body member is substantially curved.

Clause 13. A capsule filling station for an apparatus for filling capsules with at least one product, the capsule filling station comprising: a dosator head configured to deliver powder from a powder bowl into a body of the capsules, the powder bowl comprising: a vacuum hopper bowl having groups of holes arranged in circular patterns around a perimeter of the vacuum hopper bowl such that when a vacuum is applied to a bottom of the vacuum hopper bowl, a vacuum is provided at each hole; and an assembly positioned over each group of holes to spread the vacuum provided at each hole.

Clause 14: The capsule filling station of Clause 13, wherein the assembly comprises an upper plate, a screen, a middle plate, and a lower shim.

Clause 15: The capsule filling station of Clause 14, wherein the lower shim and the middle plate are positioned over one of the groups of holes on the vacuum hopper bowl to provide an area for the vacuum to spread out, such that the vacuum is applied to a plurality of slots formed in the middle plate.

Clause 16: The capsule filling station of Clause 15, wherein the screen and the upper plate transfer the vacuum to the powder in the vacuum hopper bowl.

Clause 17: The capsule filling station of Clause 16, wherein the upper plate defines a plurality of slots to transfer the vacuum to the powder in the vacuum hopper bowl.

Clause 18: The capsule filling station of any of Clauses 14-17, wherein the upper plate comprises three posts that pass through the screen and the middle plate and are held in a surface of the vacuum hopper bowl.

Clause 19: The capsule filling station of any of Clauses 15-18, wherein the plurality of slots formed in the middle plate are substantially arcuate in shape.

Clause 20: The capsule filling station of any of Clauses 15-19, wherein a number of slots formed in the middle plate corresponds to a number of dosator tubes that are provided in the dosator head.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

For the purpose of facilitating understanding of the invention, the accompanying drawings and description illustrate preferred embodiments thereof, from which the invention, various embodiments of its structures, construction and method of operation, and many advantages may be understood and appreciated.

FIG. 1 is a perspective view of a conventional apparatus for filling capsules with pharmaceutical products;

FIG. 2 is a top view of the apparatus of FIG. 1;

FIG. 3 is a perspective view of a magazine utilized by a capsule loading station of the apparatus of FIG. 1 in accordance with the present disclosure;

FIG. 4 is a front view of the magazine of FIG. 3;

FIG. 5 is a top view of the magazine of FIG. 3;

FIG. 6 is a bottom view of the magazine of FIG. 3;

FIG. 7 is a side view of the magazine of FIG. 3;

FIG. 8 is a rear view of the magazine of FIG. 3;

FIG. 9 is a front cross-sectional view of the magazine of FIG. 3;

FIG. 10 is a side cross-sectional view of the magazine of FIG. 3;

FIG. 11 is another side cross-sectional view of the magazine of FIG. 3;

FIG. 12 is a perspective view of a dosator head utilized by a powder loading station of the apparatus of FIG. 1 in accordance with the present disclosure;

FIG. 13 is a perspective view of a piston block utilized by the dosator head of FIG. 12 in accordance with the present disclosure;

FIG. 14 is a front view of the piston block of FIG. 13;

FIG. 15 is a perspective view of a dosator ejection pin assembly utilized by the dosator head of FIG. 5 in accordance with the present disclosure;

FIG. 16 is a cross-sectional view of the dosator ejection pin of FIG. 15;

FIG. 17 is an exploded view of the dosator ejection pin of FIG. 15;

FIG. 18 is a top view of a filling station and a powder bowl of the powder loading station of the apparatus of FIG. 1 in accordance with the present disclosure; and

FIG. 19 is a perspective view of a vacuum plate assembly for use with the powder bowl of FIG. 18 in accordance with the present disclosure; and

FIG. 20 is an exploded perspective view of the vacuum plate assembly of FIG. 19.

### DESCRIPTION OF THE DISCLOSURE

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

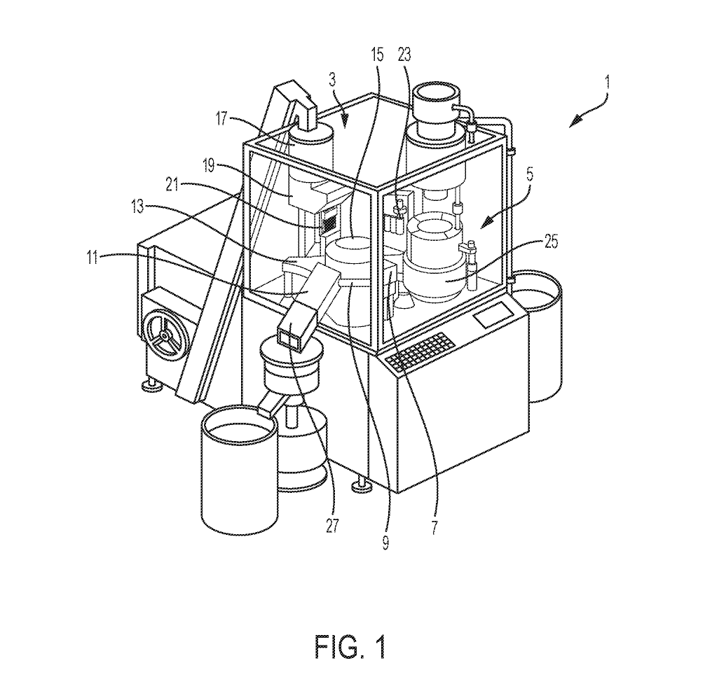

With reference to FIG. 1, an apparatus, denoted generally as reference numeral 1, for filling capsules with pharmaceutical products includes a capsule loading station, denoted generally as reference numeral 3, a powder loading station, denoted generally as reference number 5, a rejection station 7, a closing station 9, an ejection station 11, a cleaning station 13, and a rotating center hub 15. The capsule loading station 3 includes a hopper 17 for receiving empty capsules, a lower hopper support 19 in communication with the hopper 17, and a magazine 21 in communication with the lower hopper support 19. The powder loading station 5 includes a dosator head 23 and a powder bowl 25. The dosator head 23 is configured to retrieve a powdered pharmaceutical product from the powder bowl 25 and deliver the powdered pharmaceutical product to the empty capsules, as will be discussed in greater detail hereinafter. The rotating center hub 15 includes a rotating body having a plurality of upper and lower bushings for receiving the empty capsules, separating the empty capsules into a cap and a body, and delivering the capsules to the various stations. In one example, the upper and lower bushings are segment plates with bushing holes machined into one of the plates.

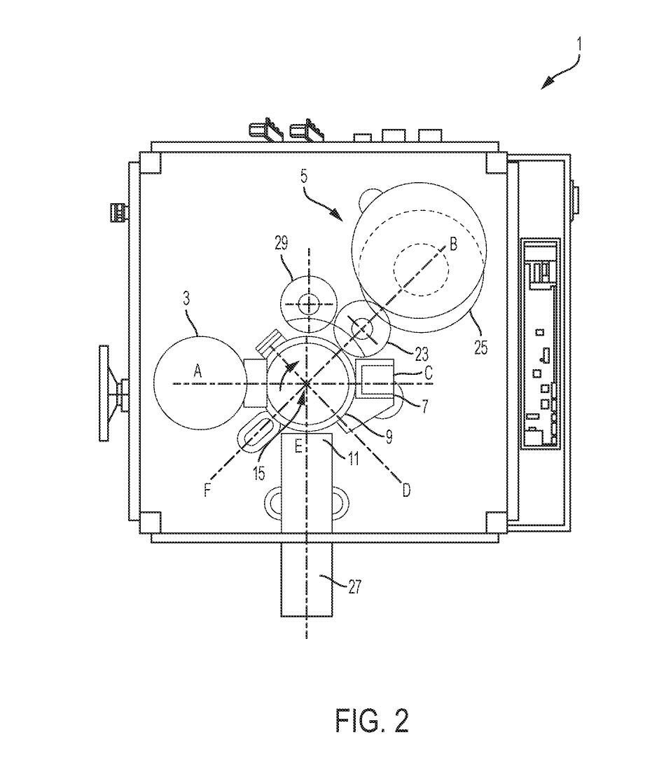

With reference to FIG. 2 and with continuing reference to FIG. 1, the operation of the apparatus will be described. Initially, empty capsules are added to the hopper 17 at step A. The capsules travel through the lower hopper support 19 to the magazine 21 that is located below the hopper 17. The magazine 21 moves up and down to load capsules into the top of the magazine 21 while capsules are released from the bottom of the magazine 21 when in its lowest position. The released capsules fall into a rectifier block (not shown) and are pushed toward the center hub 15 by a horizontal push blade (not shown) with the body of the capsule facing toward the center hub 15. The capsule is then pushed downward by a vertical push blade (not shown) into the upper bushing of the center hub 15 where a vacuum is applied to the capsule separating the body from the cap. The cap remains in the upper bushing while the body is transferred to the lower bushing by the vacuum.

At step B, the center hub 15 rotates clockwise to the powder loading station 5. As the hub 15 rotates from the capsule loading station 3 to the powder loading station 5, the lower bushing plate moves outward from the center hub 15 which allows for the loading of a powder pharmaceutical product into the body of the capsule. At the powder loading station 5, powder is picked up by the dosator head 23 from the powder bowl 25. The dosator head 23 is then rotated 180 degrees in order to deposit powder into the body of the capsule.

At step C, the center hub 15 rotates clockwise to the rejection station 7, the capsules that did not separate at step A are eliminated as follows. If capsules did not separate, the body of the capsule is still inserted into the cap. A pin (not shown) of the rejection station 7 moves upward toward the capsule hitting the body bottom and pushes the unopened capsule into a capsule rejection box (not shown). If the body is separated from the cap, the pin moves upward inside the cap without touching resulting in no movement of the cap.

At step D, the center hub 15 rotates from the rejection station 7 to the closing station 9. At the closing station 9, the lower bushing moves inward toward the center of the center hub 15 resulting in the upper and lower bushings being lined up. A pin (not shown) then pushes the body of the capsule into the cap, thereby closing the capsule.

At step E, the center hub 15 rotates from the closing station 9 to the ejection station 11. At the ejection station 11, a pin (not shown) moves upward to hit the bottom of the assembled capsule pushing it out of the upper bushing into a discharge chute 27 where air forces the capsule down the chute 27.

Finally, at step F, the center hub 15 rotates from the ejection station 11 to the cleaning station 13. At the cleaning station 13, a hollow pin (not shown) with an air jet moves upward through the lower and upper bushings blowing out excess powder to clean the bushings. The rotating center hub 15 then rotates to the capsule loading station 3 and the process is repeated.

Optionally, between steps A and B, a beading loading station 29 may be provided. At the beading loading station 29, beads from a bead dosator head can be added to the body of the capsule.

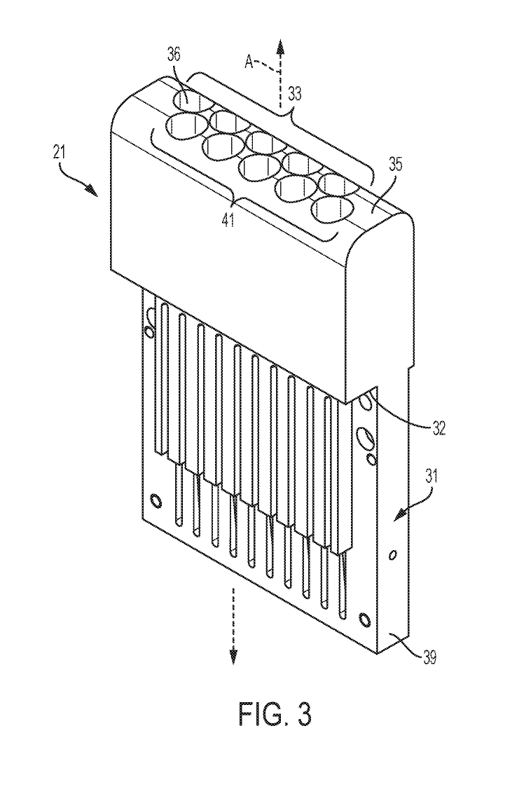

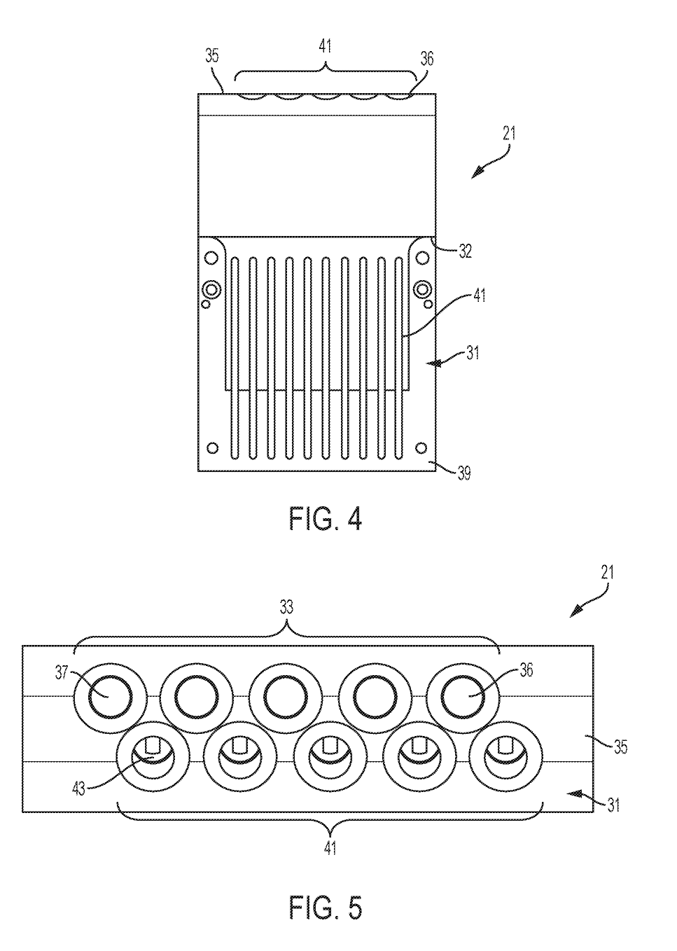

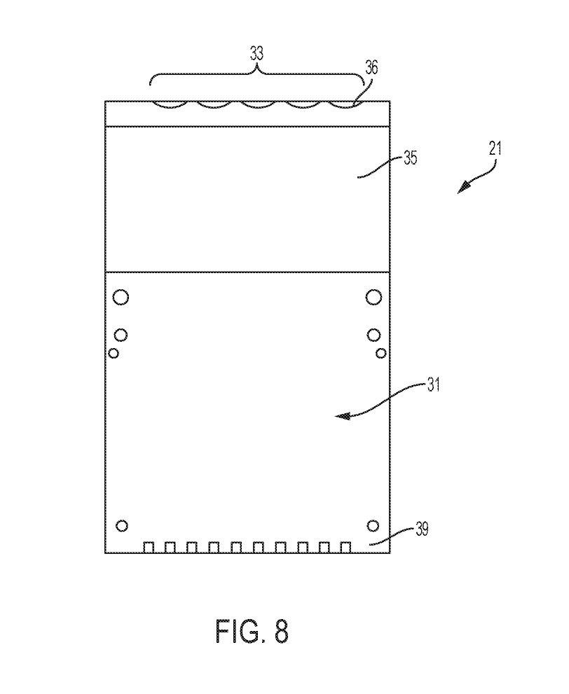

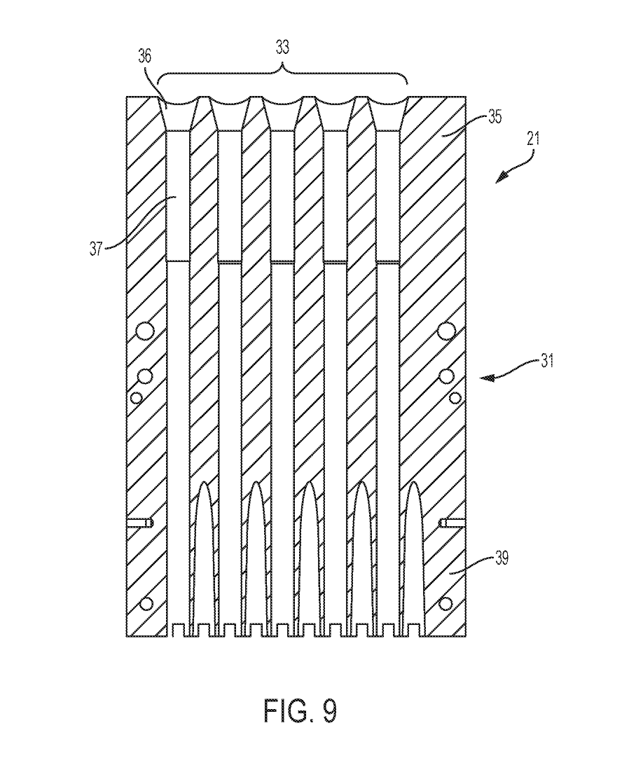

Several improvements to the above described apparatus 1 for filling capsules with a pharmaceutical product that increase the output of the apparatus will now be described. With reference to FIGS. 3-11, a magazine 21 allowing for an increased number of capsules per segment has been developed. Due to the arrangement of the magazine 21 described below, an increased number of capsules per segment is provided, thereby increasing the number of capsules that can be filled by the apparatus 1. Specifically, the magazine 21 includes a body 31, a first row of openings 33 defined in the body 31 with one end defined in a top portion 35 of the body 31 in communication with the hopper 17, a plurality of first passages 37 in communication with each of the openings in the first row of openings 33 extending straight through the body 31 to a bottom portion 39 of the body 31, a second row of openings 41 defined in the body 31 and extending parallel to the first row of the openings 33 on the top portion 35 of the body 31 in communication with the hopper 17; and a plurality of second passages 43 in communication with each of the openings of the second row of openings 41 extending at an angle through the body 31 to the bottom portion 39 of the body 31. In one example, as shown in FIGS. 3 and 5, the first row of openings 33 of the magazine 21 includes five openings and the second row of openings 41 includes five openings parallel to the first row openings 33. However, this is not to be construed as limiting the present disclosure as any suitable number of openings that may by physically incorporated into the bounds of the body 31 of the magazine 21 may be utilized.

In one aspect of the disclosure, the openings 33, 41 and the passages 37, 43 have a substantially circular cross-section and are sized to receive the capsules from the lower hopper support 19. The top portion 35 of the body 31 may have a larger thickness than the bottom portion 39 of the body 31. Due to the differences in thickness between the top portion 35 and the bottom portion 39 of the body 31, an extension surface 32 is defined on the body 31. The extension surface 32 provides an extended portion of the body 31 that assists in permitting angled passages 43 to be defined therein. The plurality of openings 41 may be offset from the plurality of openings 33 such that the center of the openings 41 are positioned between each of the center of the corresponding openings 33. Each of the openings 33, 41 may include a chamfered surface 36 that assists in directing the capsules into the openings 33, 41 and into the passages 37, 43. The chamfered surfaces 37 may be sloped such that the openings 33, 41 may have a larger diameter in an upper portion of the openings 33, 41 and a smaller diameter in a lower portion of the openings 33, 41 such that the diameter of the openings 33, 41 is gradually reduced from the upper portion to the lower portion of the openings 33, 41. The diameter of the openings 33, 41 at the lower portion is substantially equal to the diameter of the corresponding passages 37, 43. The passages 37, 43 may have a substantially constant diameter along the length of the passages 37, 43.

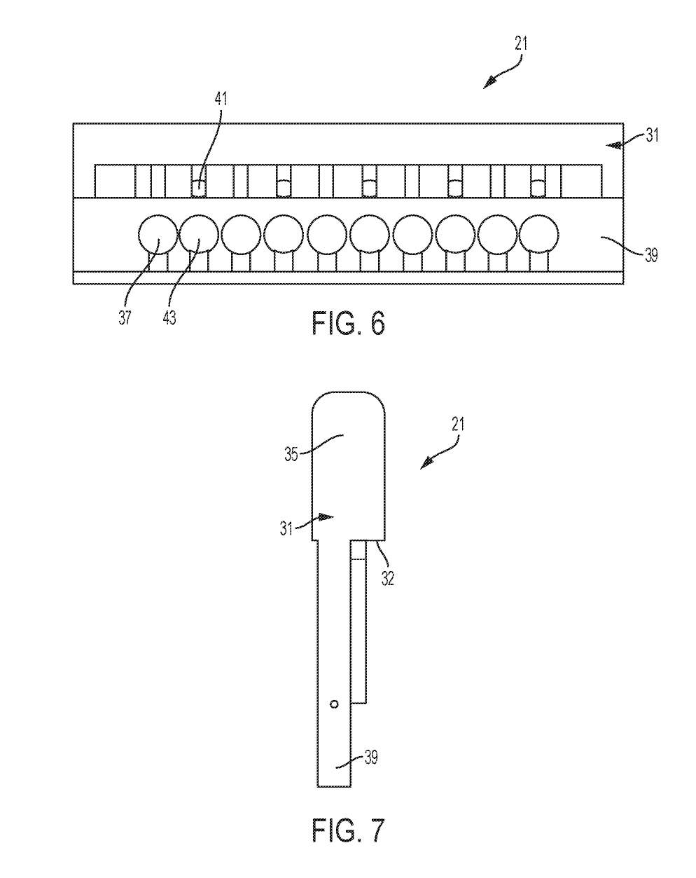

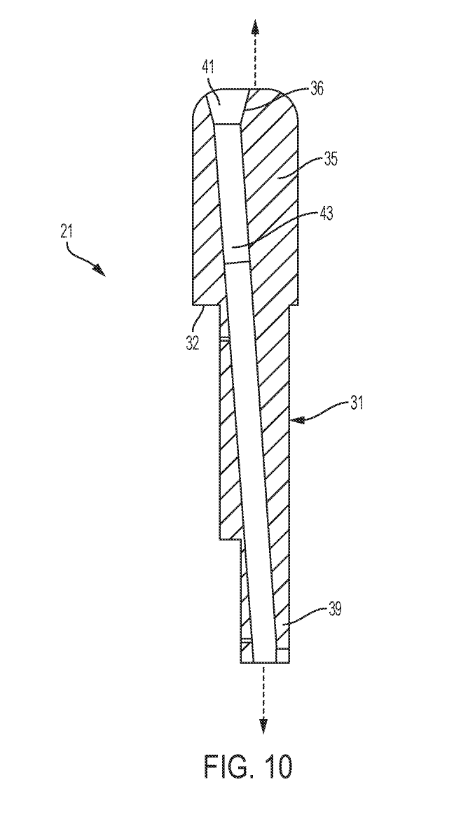

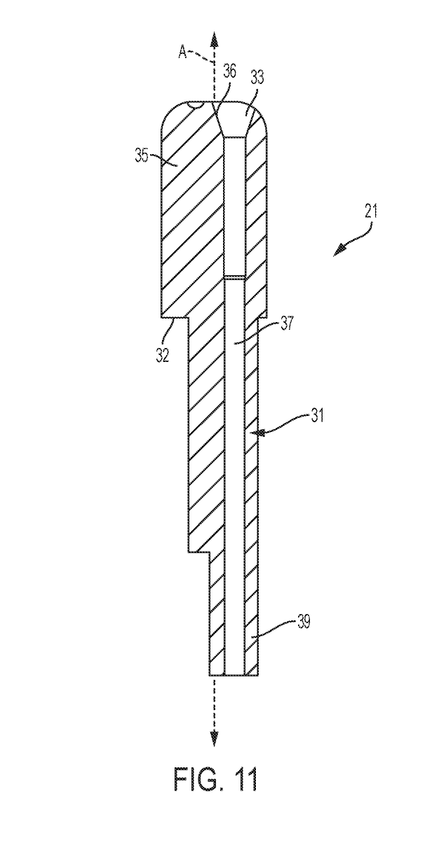

As shown in FIG. 11, the first passages 37 are defined in the body 31 such that a longitudinal length of the first passages 37 extends parallel with a longitudinal axis A of the body 31. As shown in FIG. 10, the second passages 43 may extend at an angle of about 4 to 5 degrees relative to the longitudinal axis A through the body 31 to the bottom portion 39 of body 31. It is also contemplated that the second passages 43 may extend at a plurality of alternative angles based on the dimensions of the body 31. The first passages and the second passages 37, 43 are then configured to form a single row of openings at the bottom portion 39 of the body 31. As shown in FIGS. 6 and 10, due to the inclination of the passages 43 and the offset arrangement of the openings 41 relative to the openings 33, the passages 43 are defined to extend from a rear portion of the top portion 35 of the body 31 to a forward portion of the bottom portion 39 of the body 31 to align with the passages 37 at the bottom portion 39 of the body 31. The openings of the passages 37, 43 in the bottom portion 39 of the body 31 are aligned with one another, such that the passages 37, 43 are not offset from one another. Using this arrangement, an increased number of passages 37, 43 are defined in the body 31 to allow for an increased number of capsules that are supplied to the dosator head 23, thereby increasing the output of the entire capsule filling apparatus 1. The magazine 21 provides an additional row of passages 37, 43 capable of receiving additional capsules. Most conventional magazines include only a single row of passages and have a reduced thickness such that an additional row of passages could not be defined in the magazine. The inclusion of an additional row of passages in current magazines would require an increase in the magazine body size, which would require an entire redesign of the capsule filling apparatus. The magazine 21 of the present disclosure, includes two rows of passages 37, 43 to increase the capsule output production of the apparatus 1.

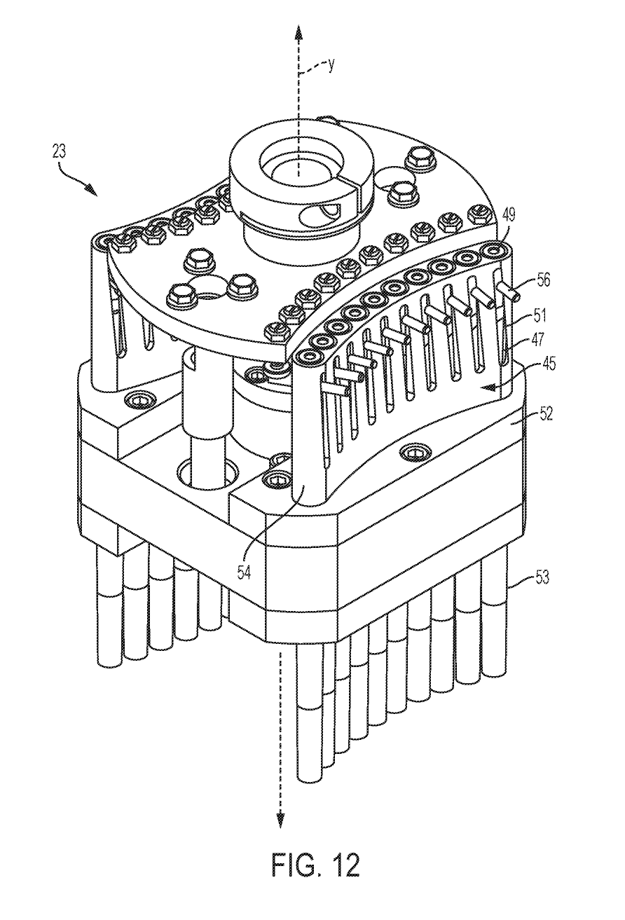

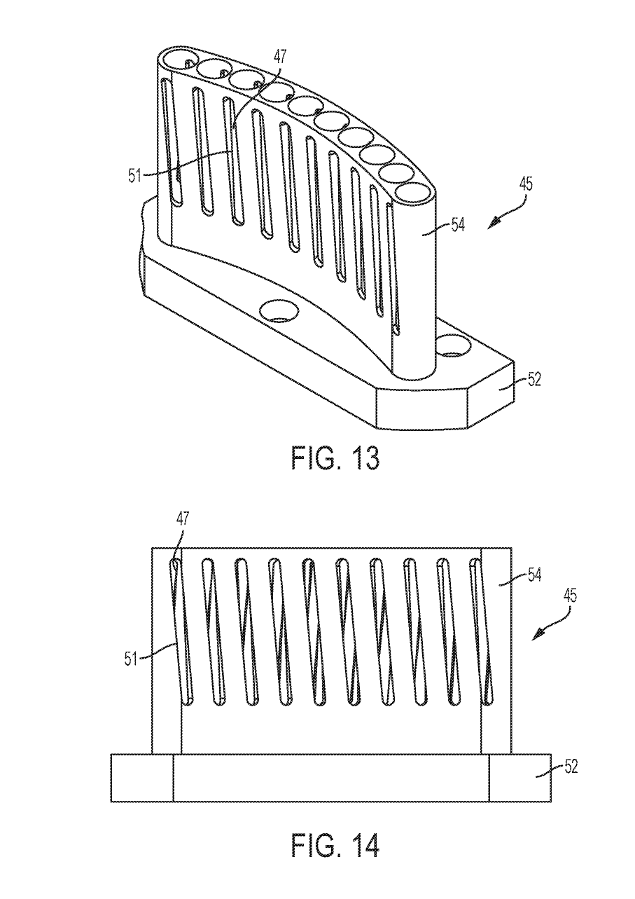

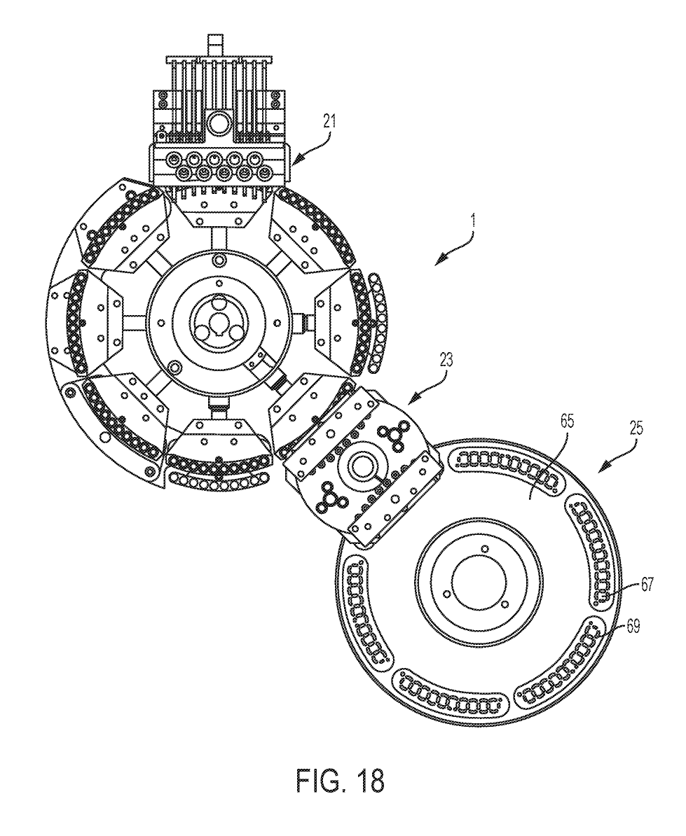

With reference to FIGS. 12-14, by increasing the number of openings in the magazine 21, a greater number of empty capsules is delivered to the apparatus 1. In order to accommodate the filling of these capsules, the dosator head 23 has also been improved. Specifically, the dosator head 23 is configured to deliver powder from a powder bowl 25 (shown in FIG. 18) into the body of the capsule. The dosator head 23 includes a solid piston block 45 mounted for rotation around a vertical axis Y such that the dosator head 23 is configured to retrieve powder from the powder bowl 25 when in a first position and deliver powder to a capsule in the lower bushing when in a second position. A plurality of passages 47 are defined in the piston block 45 for receiving pistons 49. The piston block 45 allows for the close placement and positioning of the dosator tubes 53 and pistons 49 due to the one-piece construction of the piston block 45 rather than the use of individual tubes. A helix-shaped opening 51 is formed along the length of each of the passages 47 and is configured to force the piston 49 to rotate as the piston pin 56 travels along the opening 51. An opening 51 may be defined in one side of the passage 47 and another opening 51 may be defined in an opposing side of the passage 47. In one example as shown in FIGS. 13 and 14, ten passages 47 may be machined into the piston block 45. In this example, the piston block 45 is solid and the passages 47 are machined into the solid block. The piston block 45 includes a base member 52 mechanically coupled to the dosator head 23 and body 54 in which the passages 47 are defined. In one aspect, the body 54 may be substantially curved. This design enables the close placement of ten (10) dosator tubes 53 positioned beneath the solid piston block 45 for feeding powder into a 10-hole bushing or segment plate that holds capsules for insertion of the powder. The dosator tubes 53 are each provide with an ejection pin 50 to eject the powder from the dosator head 23 into the capsules. The ten passages 47 correspond to the ten passages 37, 43 of the magazine 21. During operation of the apparatus 1, ten capsules are loaded into the magazine 21 and supplied to the dosator head 23. Therefore, based on the number of passages defined in the magazine 21, the number of passages 47 defined in the piston block 45 can be adjusted. During operation of the dosator head 23, the ejection pin 50 moves downward to contact the top surface of the piston 49. The piston 49 continues to move downward as the piston pin 56 causes the piston 49 to rotate, resulting in the release of powder from the tip of the piston 49. The piston tip travels to the end of the dosator tube 53 to eject the powder.

The helix shape opening 51 defined in the passages 47 assists in removing the slug of powder from the piston 49. In one aspect of the disclosure, the term “helix” indicates that the opening 51 is substantially twisted or curved about the longitudinal axis of the passage 47. In one aspect, the upper end of the opening 51 is defined in a first angular position on the outer circumference of the passage 47 and a lower end of the opening 51 is defined in a second angular position on the outer circumference of the passage 47. A portion 56 of the piston 49 extends through the opening 51 such that the portion 56 is directed and rides along the surface defined by the opening 51 when the piston 49 is moved vertically within the passage 47. As the portion 56 rides along the surface of the opening 51, the piston 49 is twisted within the passage 47 due to the twisting configuration of the opening 51. The piston 49 is twisted relative to the slug held in the dosator tube 53 such that the rotation of the piston 49 assists in disconnecting the slug from an end of the piston 49 so the slug can be deposited into a capsule. Therefore, unlike conventional piston blocks that include substantially linear openings defined in the passages in which the slugs will often stick to the end of the piston pin resulting in an underweight capsule, the helix-shaped openings 51 of the passages 47 of the present piston block 23 assist in easily disconnecting the slug from the end of the piston 49 by rotating the piston 49 relative to the slug.

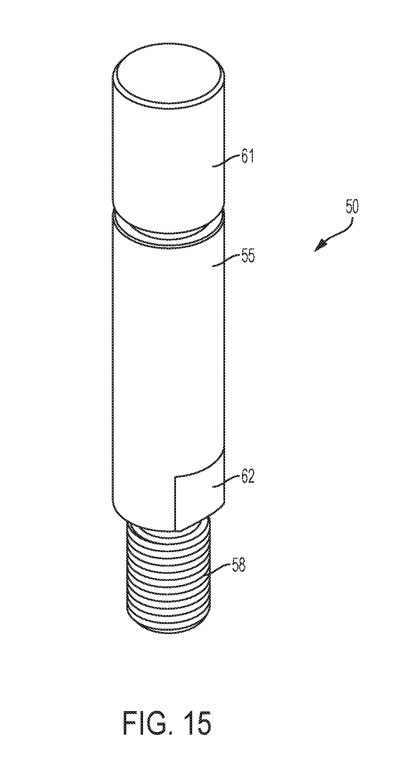

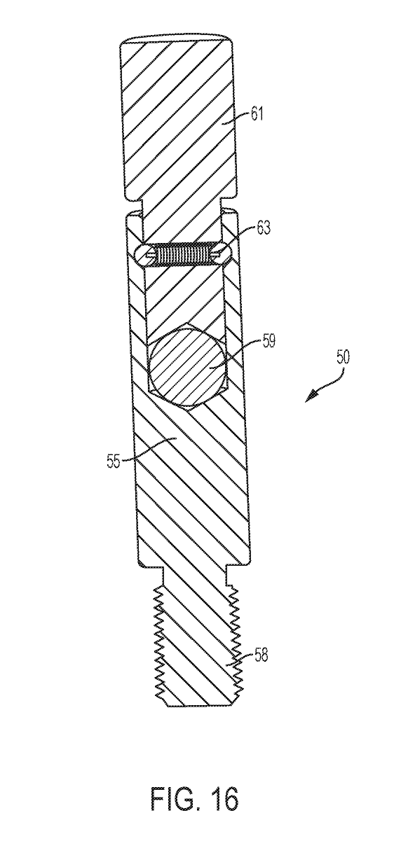

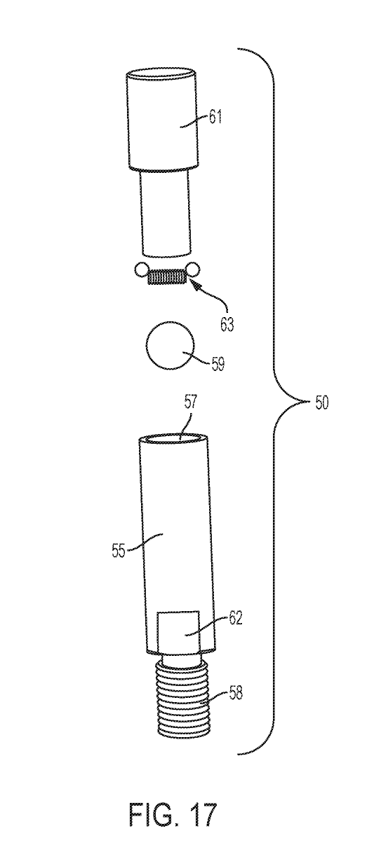

In addition, with reference to FIGS. 15-17, it is also beneficial to reduce the diameter of the overall dosator ejection pins 50 while maintaining a tip rotation and max load bearing capacity (i.e., a large diameter) for the ejection pins 50. Accordingly, an ejection pin 50 has been developed to maximize the load carrying capacity (i.e., the cross sectional area) and surface contact between the top of the pistons 49 and a compression punch or hammer (not shown). The ejection pin 50 includes a first pin portion 55 having an opening 57 for receiving a ball 59 and a compression pin 61 operatively connected to the ball 59. The ejection pin 50 further includes a spring and ball assembly 63 for connecting the first pin portion 55 to the compression pin 61. The first pin portion 55 includes a threaded end 58 configured for connection to the compression hammer. The first pin portion 55 also includes a notch 62. The notch 62 assists in tightening the threaded end 58 to the compression hammer. As shown in FIG. 16, the spring and ball assembly 63 holds the compression pin 61 within the first pin portion 55. The balls of the spring and ball assembly 63 are held in recesses defined in the inner surface of the first pin portion 55. The spring of the spring and ball assembly 63 extends through the compression pin 61. Based on movement of the first pin portion 55 towards the compression pin 61, the ball 59 presses against the compression pin 61, thereby moving the piston 49 downward as the piston 49 turns to eject the powder. The spring and ball assembly 63 has a predetermined stiffness to permit the compression pin 61 to rotate as the piston 49 is pushed downward. With this design, the diameter of the compression pin 61 is maximized for load carrying capacity as well as surface area contact between the compression pin 61 and piston top during ejection of the powder.

By using the dosator head 23 having ten (10) dosator tubes 53 as described above, a need exists for an assembly to be provided to an existing powder bowl to accommodate the ten dosator tubes 53 while also providing ten flat areas for the compression of the powder. The flat area is required because the dosator tube 53 moves downwardly over the flat area and compression of the powder occurs with the dosator piston 49.

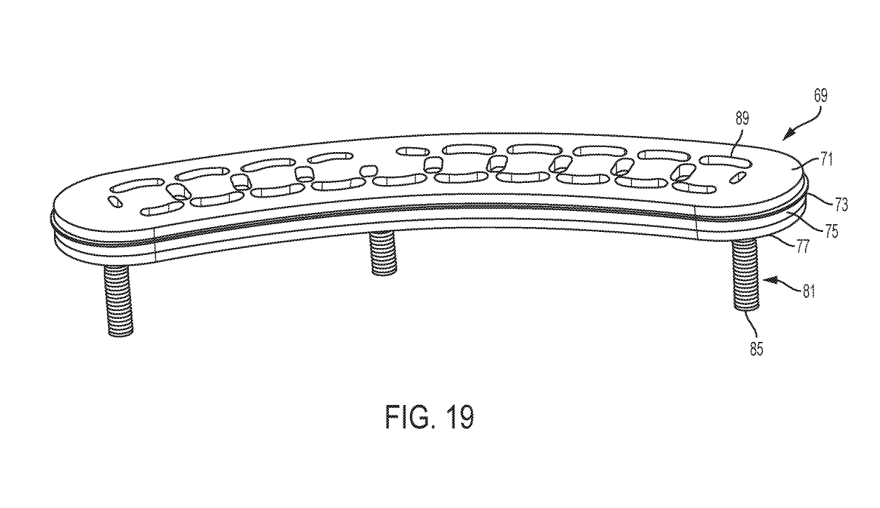

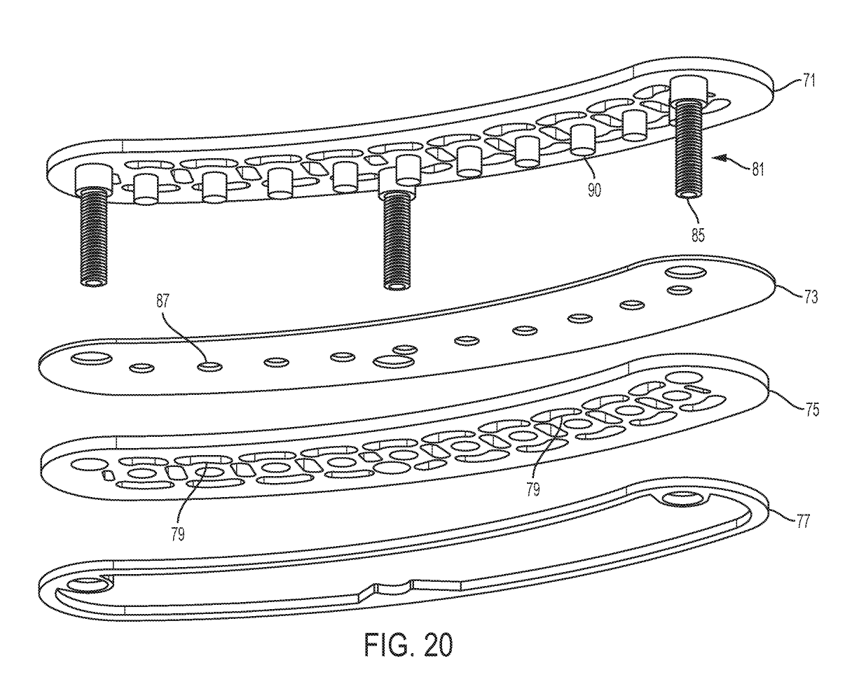

With reference to FIG. 18, the powder bowl 25 includes a vacuum hopper bowl 65 having groups of holes 67 arranged in circular patterns around a perimeter of the vacuum hopper bowl 65 such that, when a vacuum is applied to a bottom of the vacuum hopper bowl 65, a vacuum is provided at each hole 67, and an assembly 69 (see also FIGS. 19 and 20) positioned over each group of holes 67. The assemblies 69 are provided to accommodate and assist in accurately positioning the dosator tubes 53 in a flat area of the hopper bowl 65 to receive powder therefrom. Each assembly 69 includes an upper plate 71, a screen 73, a middle plate 75, and a lower shim 77. The lower shim 77 and the middle plate 75 are positioned over one of the groups of holes 67 in the vacuum hopper bowl 65 to provide an area for the vacuum to spread out for the specific group of holes 67, such that a vacuum is applied to a plurality of slots 79 formed in the middle plate 75. The lower shim 77 and the middle plate 75 are shaped and configured to enlarge the vacuum area of the groups of holes 67 such that the vacuum is established along the length of the assembly 69. The vacuum is applied to the holes 67 in the bottom of the powder bowl 65. The lower shim 77 surrounds the holes 67, creating a space between the powder bowl 65 surface. The bottom of the middle plate 75 allows the vacuum to spread out to all of the holes 79 in the middle plate 75. The screen 73 and the upper plate 71 are positioned over the lower shim 77 and the middle plate 75 to transfer the vacuum that is spread out by the lower shim 77 and the middle plate 75 to the powder in the vacuum hopper bowl 65. The screen 73 defines a plurality of apertures 87 used to locate the screen 73 into the bottom of the upper plate 71. The apertures 87 receive support posts 90 that extend from the bottom of the upper plate 71 that allow for the transfer of compression forces to the powder bowl 65 surface as a result of the powder being compressed on the top of the upper plate 71. Likewise, the upper plate 71 defines a plurality of slots 89 through which the vacuum is spread so that a flat area on top of the upper plate 71 establishes a flat vacuum surface for the dosator tubes 53. The upper plate 71 includes three posts 81 that pass through the screen 73, the middle plate 75, and the lower shim 77. The threaded posts 81 pass through holes in the vacuum bowl 65. The posts 90 on the upper plate 71 allow for compression of the powder by the dosator piston during compression transferring compressive forces to the powder bowl 65. Using these assemblies 69, a pre-existing vacuum hopper bowl 65 can be retrofitted to accommodate the ten dosator tubes 53 of the dosator head 23, thereby increasing output production for the apparatus 1.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements. For example, it is to be understood that the present invention contemplates that, to the extent possible, one or more features of any embodiment can be combined with one or more features of any other embodiment.

The invention claimed is:

1. A magazine for use with an apparatus for filling capsules with at least one product, the magazine comprising:
a body;
a first row of openings provided on a top portion of the body;
a plurality of first passages extending parallel with a longitudinal axis of the body to a bottom portion of the body, one first passage in communication with each of the openings in the first row of openings;
a second row of openings provided parallel to the first row of openings on the top portion of the body; and
a plurality of second passages extending at an angle relative to the longitudinal axis of the body and through the body to the bottom portion of the body, one second passage in communication with each of the openings of the second row of openings.

2. The magazine of claim 1, wherein the first row of openings comprises five openings and the second row of openings comprises five openings parallel to the first row openings.

3. The magazine of claim 1, wherein each of the openings of the first and second row of openings has a tapered diameter.

4. The magazine of claim 1, wherein the second passages extend at an angle of about 4 to 5 degrees through the body to the bottom portion of body.

5. The magazine of claim 1, wherein the first passages and the second passages form a single row of openings at the bottom portion of the body.

6. A dosator head used with an apparatus for filling capsules with at least one product, the dosator head comprising:
a solid piston block comprising a base member and a body member, the piston block being mounted for rotation around a vertical axis such that the dosator head is configured to retrieve powder from a powder bowl when in a first position and deliver powder to a capsule when in a second position;
a plurality of passages machined into the piston block for individually receiving piston with a helix-shaped opening formed along the length of each of the passages and configured to force the piston to rotate as the piston travels along the passage,
wherein the dosator head is configured to deliver powder from the powder bowl into a body of the capsule.

7. The dosator head of claim 6, wherein ten passages are machined into the piston block.

8. The dosator head of claim 6, wherein the pistons are configured to interact with an ejection pin comprising a three-piece main body.

9. The dosator head of claim 8, wherein the main body comprises a first pin portion having an opening for receiving a ball and a compression pin operatively connected to the ball.

10. The dosator head of claim 6, wherein the helix-shaped opening are formed to twist along an entire length of the helix-shaped opening.

11. The dosator head of claim 6, wherein front and rear sides of the passages include a helix-shaped opening.

12. The dosator head of claim 6, wherein the body member is substantially curved.

13. A capsule filling station for an apparatus for filling capsules with at least one product, the capsule filling station comprising:
a dosator head configured to deliver powder from a powder bowl into a body of the capsules, the powder bowl comprising:
a vacuum hopper bowl having groups of holes arranged in circular patterns around a perimeter of the vacuum hopper bowl such that when a vacuum is applied to a bottom of the vacuum hopper bowl, a vacuum is provided at each hole; and
an assembly positioned over each group of holes to spread the vacuum provided at each hole.

14. The capsule filling station of claim 13, wherein the assembly comprises an upper plate, a screen, a middle plate, and a lower shim.

15. The capsule filling station of claim 14, wherein the lower shim and the middle plate are positioned over one of the groups of holes on the vacuum hopper bowl to provide an area for the vacuum to spread out, such that the vacuum is applied to a plurality of slots formed in the middle plate.

16. The capsule filling station of claim 15, wherein the screen and the upper plate transfer the vacuum to the powder in the vacuum hopper bowl.

17. The capsule filling station of claim 16, wherein the upper plate defines a plurality of slots to transfer the vacuum to the powder in the vacuum hopper bowl.

18. The capsule filling station of claim 14, wherein the upper plate comprises three posts that pass through the screen and the middle plate and are held in a surface of the vacuum hopper bowl.

19. The capsule filling station of claim 15, wherein the plurality of slots formed in the middle plate are substantially arcuate in shape.

20. The capsule filling station of claim 15, wherein a number of slots formed in the middle plate corresponds to a number of dosator tubes that are provided in the dosator head.
